(19) United States
(12) Patent Application Publication
(10) Pub. No.: US 2009/0122562 A1
(43) Pub. Date: May 14, 2009

(54) CLIPPING LAMP

(76) Inventor: Wen-Sung LEE, Taichung City (TW)

Correspondence Address: Dr. BANGER SHIA, 102 Lindencrest Ct., Sugar Land, TX, 77479-5201, US

(21) Appl. No.: 11/937,424

(22) Filed: Nov. 8, 2007

(51) Int. Cl. F21V 21/088

(52) U.S. Cl. 362/396

(57) ABSTRACT

A clipping lamp includes a clip for clipping a flat object, a shell pivotally connected to the clip, at least one illuminating element supported on the shell, a reeling unit disposed in the shell, a wire connected to the illuminating elements and wound on the reeling unit and a plug connected to the wire.

### BACKGROUND OF INVENTION

1. Field of Invention

The present invention relates to a lamp and, more particularly, to a clipping lamp for clipping a flat panel display.

2. Related Prior Art

Personal computers such as desktop computers and laptop computers are common these days. A laptop computer is equipped with a flat panel display and, more particularly, a liquid crystal display. A user can use a laptop computer everywhere he or she goes. It is however difficult to have appropriate illumination while consuming a little energy everywhere. To have appropriate illumination, there must be an appropriate lamp located in an appropriate position.

The present invention is therefore intended to obviate or at least alleviate the problems encountered in prior art.

### SUMMARY OF INVENTION

It is the primary objective of the present invention to provide a clipping lamp for clipping a flat panel display of a computer.

To achieve the foregoing objective, the clipping lamp includes a clip for clipping a flat object, a shell pivotally connected to the clip, at least one illuminating element supported on the shell, a reeling unit disposed in the shell, a wire connected to the illuminating elements and wound on the reeling unit and a plug connected to the wire.

Other objectives, advantages and features of the present invention will become apparent from the following description referring to the attached drawings.

### BRIEF DESCRIPTION OF DRAWINGS

The present invention will be described via the detailed illustration of the preferred embodiment referring to the drawings.

FIG. 1 is a perspective view of a clipping lamp according to the preferred embodiment of the present invention.

FIG. 2 is an exploded view of the clipping lamp shown in FIG. 1.

FIG. 3 is another exploded view of the clipping lamp shown in FIG. 2.

FIG. 4 is a cross-sectional view of the clipping lamp shown in FIG. 1.

FIG. 5 is another cross-sectional view of the clipping lamp shown in FIG. 4.

FIG. 6 is a cross-sectional view of the clipping lamp in another position than shown in FIG. 1.

FIG. 7 is another cross-sectional view of the clipping lamp shown in FIG. 6.

FIG. 8 is a partial perspective view of a flat panel display of a laptop computer clipped by the clipping lamp shown in FIG. 1.

### DETAILED DESCRIPTION OF PREFERRED EMBODIMENT

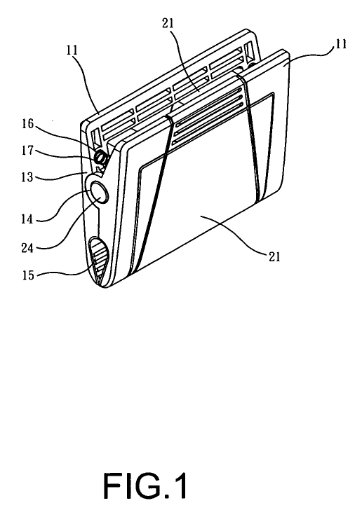

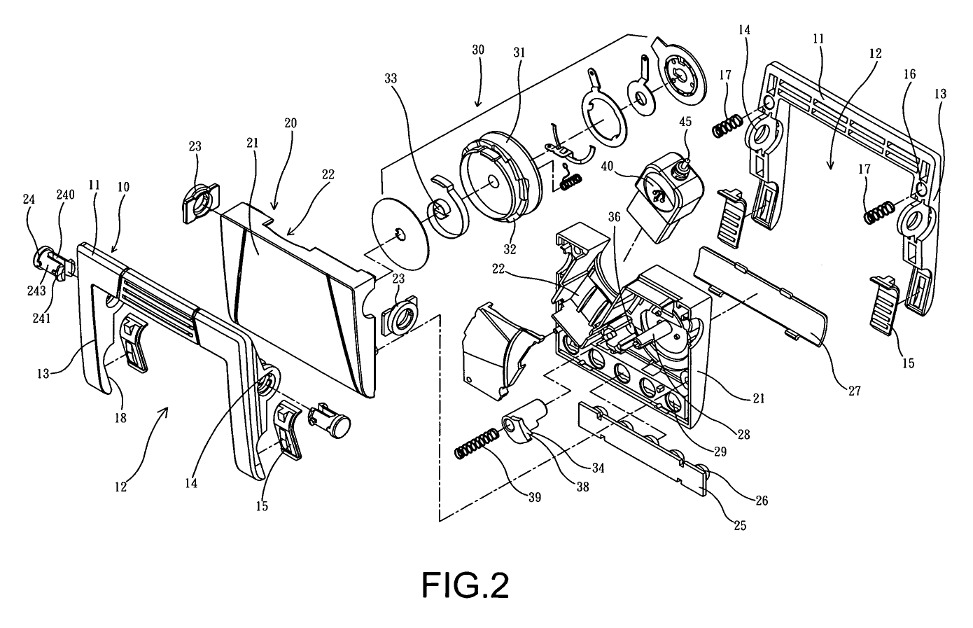

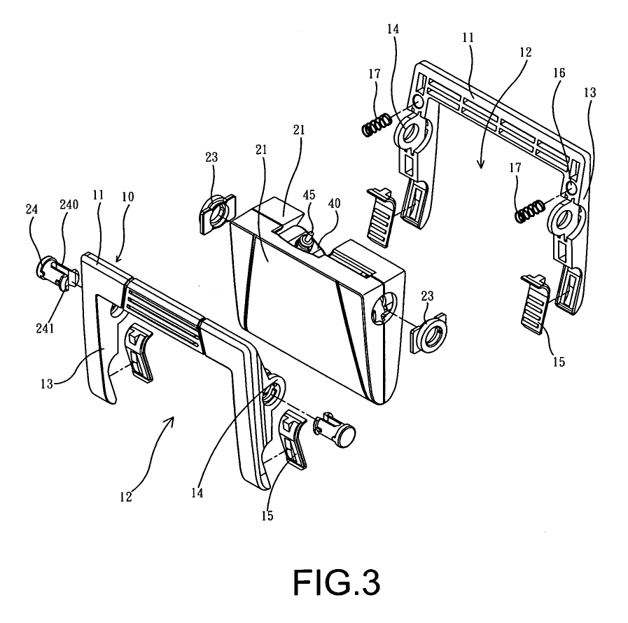

Referring to FIGS. 1 through 3, a clipping lamp includes a clip 10, a shell 20 pivotally connected to the clip 10, illuminating elements 26 supported on the shell 20, a reeling unit 30 disposed in the shell 20, a wire 45 connected to the illuminating elements 26 and wound on the reeling unit 30.

The clip 10 includes two jaws 11. Each of the jaws 11 includes two legs 13 between which a space 12 is defined. An ear 14 is formed on a middle portion of each of the legs 13. A soft pad 15 is disposed in a recess 18 defined in each of the legs 13. Each of the legs 13 includes an indent 16 for receiving an end of a spring 17. The springs 17 keep the clip 10 in a closed position.

The shell 20 includes two halves 21. Each of the halves 21 includes a cutout 22. The cutouts 22 together form an opening when the halves 21 are joined together. Two rings 23 are sandwiched between the halves 21 so that the former and the latter can only be rotated together. Two pins 24 are inserted through the ears 14 and the rings 23, thus pivotally connecting the shell 20 to the clip 10. Each of the pins 24 includes two arms 243 separated from each other by a slit 240 defined therein. Each of the arms 243 is formed with a flange 241. The slit 240 allows the arms 243 to move towards each other so that each of the pins 24 can easily be inserted through the related ear 14 and the ring 23. Then, the arms 243 expand so that the flanges 241 hook the related ring 23.

The illuminating elements 26 are preferably light-emitting diodes connected to a circuit board 25 located between the halves 21. One of the halves 21 includes a plurality of apertures 29 through which the illuminating elements 26 are observable. A lens 27 is attached to the shell 20, over the illuminating elements 26. Thus, light emitted from the illuminating elements 26 is scattered by the lens 27.

One of the halves 21 includes an axle 28 formed thereon and another aperture 36 defined therein.

The reeling unit 30 includes a reel 31, ratchets 32, coil spring 33, restraint 34, a button 38 and a helical spring 39. The reel 31 is rotationally mounted on the axle 28. The ratchets 32 are formed on the reel 31. The coil spring 33 includes an end connected to the reel 31 and another end connected to the axle 28. The button 38 is movably disposed in the shell 20, with only one end exposed from the aperture 36 so that the button 38 can be pushed. The restraint 34 is formed on the button 38. The restraint 34 is used for engagement with the ratchets 32, thus preventing the rotation of the reel 31 in only one of two directions, i.e., avoiding the reeling in of the wire 45, but allowing the reeling out of the wire 45. The helical spring 39 is mounted on the axle 28. The helical spring 39 is compressed between the button 38 and one of the halves 21. The helical spring 39 retains the restraint 34 in engagement with the ratchets 32.

The wire 45 is connected to a plug 40. The wire 45 is wound on the reel 31. The plug 40 can be moved into and out of the shell 20 through the opening consisting of the cutouts 22 of the halves 21 of the shell 20. The plug 40 is a USB plug.

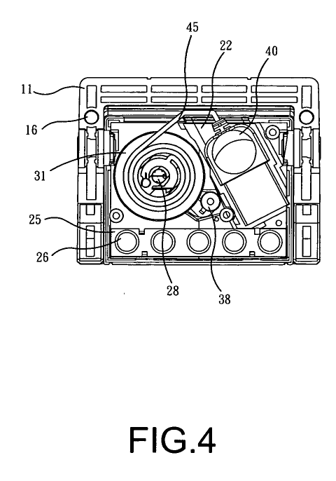

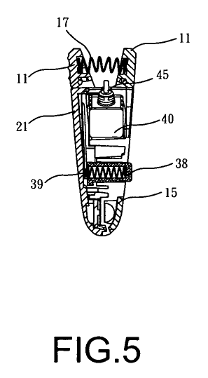

Referring to FIGS. 4 and 5, the wire 45 is reeled in. The plug 40 is disposed in the shell 20.

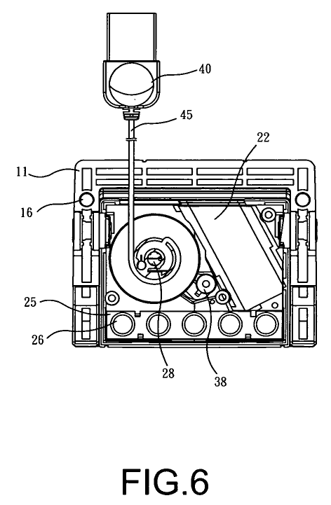

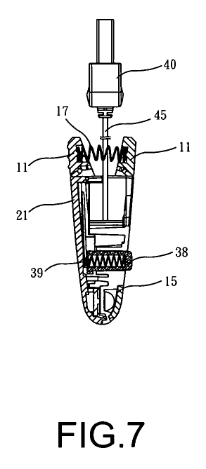

Referring to FIGS. 6 and 7, the wire 45 is reeled out. The plug 40 is moved out of the shell 20.

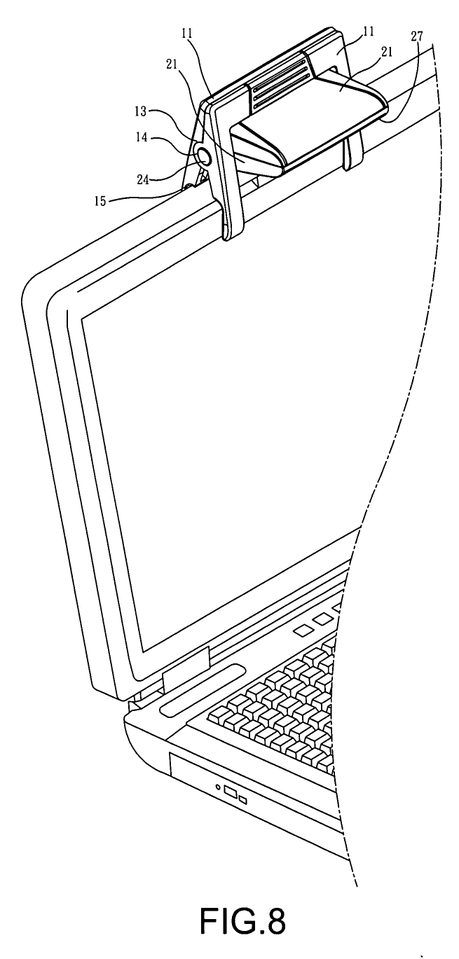

Referring to FIG. 8, the clip 10 clips a flat panel display of a laptop computer. The shell 20 is pivoted from the clip 10. If turned on, the illuminating elements 26 emit light to irradiate the flat panel display of the laptop computer.

Being light-emitting diodes, the illuminating elements 26 can provide adequate illumination while consuming a little energy. The clip 10 clips the flat panel display so that the illuminating elements 26 emit light onto the flat panel display. Therefore, appropriate illumination is provided.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A clipping lamp comprising:
a clip for clipping a flat object;
a shell pivotally connected to the clip;
at least one illuminating element supported on the shell;
a reeling unit disposed in the shell;
a wire connected to the illuminating elements and wound on the reeling unit; and
a plug connected to the wire.

2. The clipping lamp according to claim 1, wherein the clip comprises two jaws pivotally connected to each other and at least one spring compressed between the jaws.

3. The clipping lamp according to claim 2, wherein each of the jaws comprises two legs between which the shell can be located.

4. The clipping lamp according to claim 3 comprising two pins for pivotally connecting the legs of one of the jaws to the legs of the other jaw.

5. The clipping lamp according to claim 4, wherein each of the legs is formed with an ear through which a related one of the pins is inserted.

6. The clipping lamp according to claim 3 comprising four pads each attached to a related one of the legs of the jaws.

7. The clipping lamp according to claim 3, wherein each of the legs of the jaws comprises an indent for receiving a related one of the ends of a related one of the springs.

8. The clipping lamp according to claim 1, wherein the shell comprises two halves joined together.

9. The clipping lamp according to claim 8, wherein one of the halves comprises an axle for supporting the reeling unit.

10. The clipping lamp according to claim 1, wherein the shell comprises an opening through which the plug can be moved.

11. The clipping lamp according to claim 1, wherein the shell comprises at least one aperture through which the illuminating element is observable.

12. The clipping lamp according to claim 1, wherein the illuminating element is a light-emitting diode.

13. The clipping lamp according to claim 1 comprising a circuit board connected to the illuminating element and disposed in the shell.

14. The clipping lamp according to claim 1 comprising a lens attached to the shell, over the illuminating element.

15. The clipping lamp according to claim 1, wherein the reeling unit comprises a reel and a coil spring formed with an end connected to the reel and another end connected to the shell.

16. The clipping lamp according to claim 15, wherein the reeling unit comprises a plurality of ratchets formed on the reel and a restraint for engagement with the ratchets, thus preventing the rotation of the reel in one of two directions, i.e., avoiding the reeling in of the wire, but allowing the reeling out of the wire.

17. The clipping lamp according to claim 16, wherein the reeling unit comprises a button connected to the restraint and movably disposed in the shell, with only an end exposed from an aperture defined in the shell so that the button can be pushed to disengage the restraint from the ratchets.

18. The clipping lamp according to claim 1, wherein the plug is a USB plug.
